(19) United States
(12) Patent Application Publication
(10) Pub. No.: US 2018/0181491 A1
(43) Pub. Date: Jun. 28, 2018

(54) TARGETED CACHE FLUSHING

(71) Applicant: Apple Inc., Cupertino, CA (US)

(72) Inventors: Anthony P. DeLaurier, Los Altos, CA (US); Luc R. Semeria, Palo Alto, CA (US); Gokhan Avkarogullari, Cupertino, CA (US); David A. Gotwalt, Winter Springs, FL (US); Robert S. Hartog, Windermere, FL (US); Michael J. Swift, San Francisco, CA (US)

(21) Appl. No.: 15/389,153

(22) Filed: Dec. 22, 2016

(51) Int. Cl. G06F 12/0891; G06F 12/0895

(52) U.S. Cl. CPC G06F 12/0891; G06F 2212/455; G06F 2212/60; G06F 12/0895

(57) ABSTRACT

Techniques are disclosed relating to flushing cache lines. In some embodiments, a graphics processing unit includes a cache and one or more storage elements configured to store a plurality of command buffers that include instructions executable to manipulate data stored in the cache. In some embodiments, ones of the cache lines in the cache are configured to store data to be operated on by instructions in the command buffers and a first tag portion that identifies a command buffer that has stored data in the cache line. In some embodiments, the graphics processing unit is configured to receive a request to flush cache lines that store data of a particular command buffer, and to flush ones of the cache lines having first tag portions indicating the particular command buffer as having data stored in the cache lines while maintaining data stored in other ones of the cache lines as valid.

### BACKGROUND

### Technical Field

This disclosure relates generally to graphics processing, and, more specifically, to evicting cached data.

### Description of the Related Art

Generally, a graphics processing unit (GPU) is designed to execute instructions to generate images that are intended for output to a display or accelerating computation. The GPU can usually perform several graphical tasks, such as clipping, texturing, shading, and the like, before sending an image to the display. GPUs can also perform computation tasks that read and write images or data stored in memory. These instructions often manipulate data stored in caches located throughout the GPU. As such, a GPU often implements a memory hierarchy where caches located closer to the cores of the GPU are smaller in size, but faster at presenting data to the cores than caches located farther away. Throughout the execution of the instructions, the GPU typically flushes data in entries in these caches to evict data that is not thought to be needed in the near feature (e.g., to make room for new data).

### SUMMARY

The present disclosure describes embodiments of a system and method for flushing and invaliding data stored in a cache that has been tagged with particular identifiers. In various embodiments, a graphics processing unit includes one or more storage elements, execution circuitry, and caching circuitry. In some embodiments, the one or more storage elements are configured to store one or more command buffers that include instructions that are executable to manipulate data stored in the caching circuitry. In some embodiments, the execution circuitry is configured to retrieve the command buffers from the one or more storage elements and execute the instructions included in the command buffers. In some embodiments, the caching circuitry includes a plurality of entries configured to store data for a command buffer and associate the stored data with a tag portion that indicates the command buffer. The caching circuitry may associate the stored data with additional tag portions that may indicate particular processors of the execution circuitry, memory contexts, or threads. In one embodiment, the graphics processing unit is configured to receive a request to flush data associated with a command buffer and flush caches lines of the caching circuitry that have tag portions indicating the command buffer as having data stored in the cache lines.

In various embodiments, a graphics processing unit is configured to execute instructions for generating an identifier that indicates a command buffer that includes instructions that are executable to manipulate data stored in a cache. In some embodiments, the graphics processing unit tags one or more cache lines in the cache with the identifier in response to executing the instructions included in the command buffer. The graphics processing unit may execute instructions to send a flush request to the cache, which includes the identifier. The flush request may cause one or more lines of the cache that are tagged with the identifier to be flushed. In some embodiments, the cache may flush additional cache lines that have tag portions indicating that instructions in multiple command buffers have been executed to manipulate data in the same cache line.

### BRIEF DESCRIPTION OF THE DRAWINGS

FIG. 1 is a block diagram illustrating exemplary elements of a graphics processing unit that includes multiple caches, according to some embodiments.

FIG. 2A is a timing diagram illustrating exemplary execution of command buffers, according to some embodiments.

FIG. 2B is a block diagram illustrating an exemplary tag, according to some embodiments.

FIG. 3 is a block diagram illustrating an exemplary cache circuit, according to some embodiments.

FIG. 4 is a flow diagram illustrating an exemplary method for flushing and invaliding data stored in cache lines, according to some embodiments.

FIG. 5A is a block diagram illustrating an exemplary graphics processing flow, according to some embodiments.

FIG. 5B is a block diagram illustrating one embodiment of a graphics unit.

FIG. 6 is a block diagram illustrating an exemplary computer system, according to some embodiments.

FIG. 7 is a block diagram illustrating an exemplary computer-readable medium, according to some embodiments.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “set-associative cache configured to receive a request for a data block” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, the terms “first” and “second” may be used to describe portions of tags. The phrase “first portion” of a tag is not limited to only the high-order bits of the tag, for example.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

When a GPU wants to evict the data stored in a cache, the GPU often flushes and invalidates the entire cache. In the case that the cache is small in size, the data can be flushed quickly; however, larger caches often take significant time to flush. Furthermore, the GPU may perform several flushes within a short period of time, which results in a significant amount of cycles being spent waiting for the cache to flush. In the GPU, flushing and invalidating the cache may be performed by individual cores at the completion of their tasks. As such, data needed by a first core may be flushed as a result of a second core flushing the cache, which causes additional delays since the first core must spend cycles dealing with invalid data.

The present disclosure describes embodiments of a system and method for flushing and invaliding data stored in a cache that has been tagged with a tag value that includes a particular identifier field. This field may indicate properties of the data and/or the processing element(s) operating on the data stored in the cache such as a memory context, a command buffer, and/or a virtual address. As used herein, the term “command buffer” includes its well-understood meaning in the art, which includes a set of commands that specify operations to be performed by the GPU, where graphics data generated by the operations is available to one or more other processing elements (other than the execution circuitry performing the set of commands) after the command buffer is finished executing. For example, data may be transferred to a shared memory upon completion of a command buffer and be available for operations specified by other command buffers and/or other circuitry (e.g., to retrieve data that specifies pixel attributes to be displayed on a display device). A command buffer may include multiple different types of work, including for example compute work, pixel work, and vertex work. In some embodiments, different types of work have different corresponding schedulers.

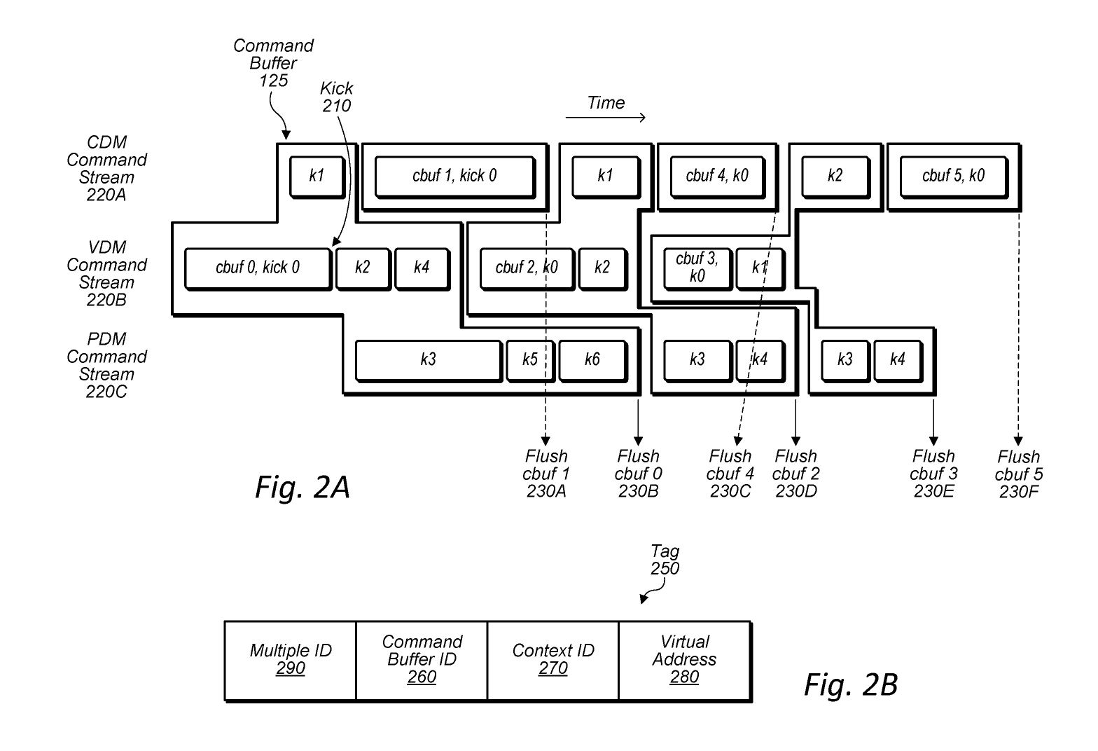

In some embodiments, a command buffer includes multiple “kicks” which refers to a grouping of one or more rendering commands. Examples of rendering commands include a command to draw procedural geometry, a command to set a shadow sampling method, a command to draw meshes, a command to retrieve a texture, a command to perform general computation, etc. A grouping of rendering commands (a “kick”) may be executed at one of various stages during the rendering of a frame. Examples of rendering stages include, without limitation: camera rendering, light rendering, etc. FIG. 2A, discussed in further detail below, shows exemplary execution of multiple command buffers, some of which include multiple groupings or kicks. In other embodiments, command buffers may include graphics work that is not subdivided or organized at a smaller granularity (e.g., without differentiating between kicks within a command buffer), or may be subdivided differently. Kicks are discussed herein with reference to various disclosed embodiments for exemplary purposes, but are not intended to limit the scope of the present disclosure.

In various embodiments, when executed by a GPU, the kicks included in a command buffer operate on and manipulate data stored in a cache. The particular identifier field (mentioned above) may associate a command buffer with portions of the cache (e.g., cache lines) that include data related to the command buffer. For example, when a particular command buffer causes data to be written into a cache line, the GPU may tag the data (which may also be referred to as tagging the cache line) with an identifier that identifies the particular command buffer. In one embodiment, instructions executing on a processor (e.g., the GPU or a CPU coupled to the GPU) program each kick with a command buffer ID. In some embodiments, the GPU is configured to extract the command buffer ID from a kick and provide the ID to the cache or circuitry configured to flush and invalidate the cache. In some embodiments, the GPU may associate a cache line with an additional identifier that indicates whether kicks in multiple command buffers have been executed to manipulate data stored in the cache line. In various embodiments, operations described herein as being performed by a processor such as the GPU may be performed by other circuitry (e.g., a flush controller), in embodiments in which a cache is not included in a GPU, for example.

In some embodiments, upon completion of all the kicks in a command buffer, the GPU may flush and invalidate cache lines storing data for the command buffer based on a command buffer ID. The GPU may compare the command buffer ID and portions of a tag associated with each cache line to determine whether the command buffer has stored data in that cache line. When the command buffer ID and a portion of the tag match, the GPU may write the data into primary memory (e.g. RAM) or a secondary memory (e.g. a hard disk) and invalidate the cache line. In some embodiments, the GPU is also configured to flush cache lines whose tag indicates that multiple command buffers have manipulate data stored in the cache line.

When a GPU is configured to flush and invalidate portions of a cache instead of the whole, the GPU may spend less cycles waiting for the cache to flush, in various embodiments. As such, the GPU may execute more command buffers within a given time interval than would otherwise be possible. Furthermore, the GPU may flush and invalidate the cache lines storing data for a first command buffer while preserving the cached data of a second command buffer, which may avoid a need to re-fetch data for the second command buffer.

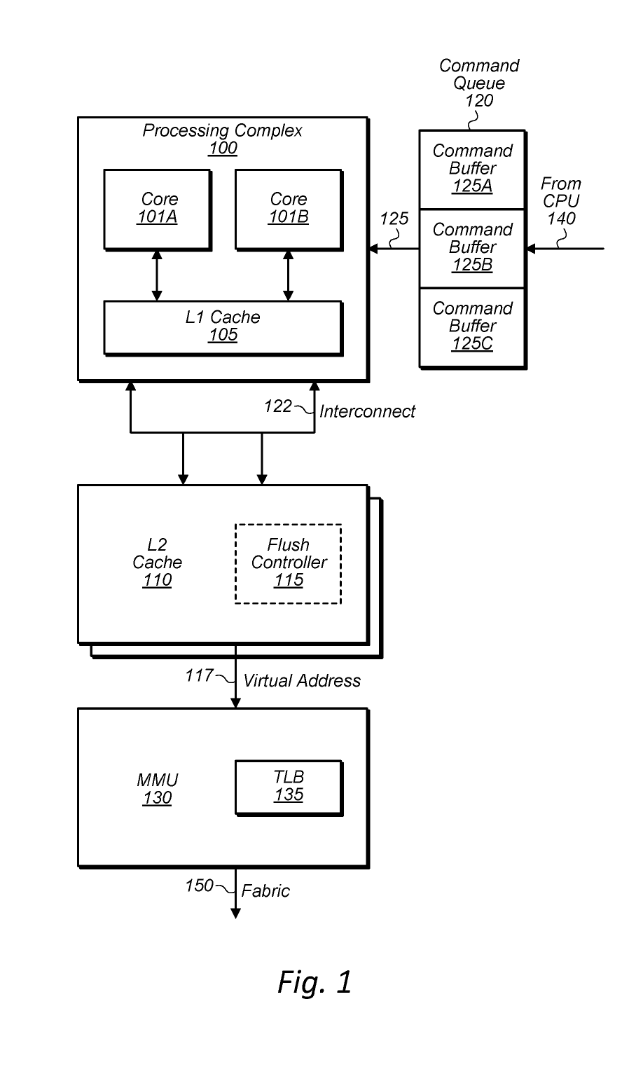

Turning now to FIG. 1, a block diagram of a portion of one embodiment of a graphics processing unit (GPU) is shown. In the illustrated embodiment, processing complex 100 includes cores 101A-B and shared L1 cache 105; in other embodiments, processing complex 100 may have several cores 101 and separate L1 caches 105 for each core 101. In some embodiments, processing complex 100 transmits and receives data and instructions from L2 cache 110 and command queue 120 via interconnect 122. L2 cache 110, in one embodiment, includes flush controller 115; in other embodiments, flush controller 115 may be circuitry separate from L2 cache 110. L2 cache may send a virtual address 117 to memory management unit (MMU) 130, which may translate virtual address 117 into a physical address and transmit the physical address to other circuitry via fabric 150. In some embodiments, command queue 120 receives one or more command buffers 125 from CPU 140 and transmits command buffers 125A-C to processing complex 100 via interconnect 122. The disclosed configuration of a GPU is shown for exemplary purposes but is not intended to limit the scope of the present disclosure. In other embodiments, any of various appropriate couplings between control circuitry, cache(s), and command buffers may be implemented.

Processing complex 100, in some embodiments, is configured to execute instructions to draw a set of objects to a display. In some embodiments, processing complex 100 serially retrieves command buffers 125, which include instructions for drawing objects, from command queue 120; in other embodiments, processing complex 100 may retrieve command buffers 125 in an out-of-order ordering. In some embodiments, processing complex 100 retrieves data from L2 cache 110 and stores the data in L1 cache 105. Furthermore, processing complex 100 may write data stored in L1 cache 105 to L2 cache 110 and/or primary memory. Processing complex 100, in some embodiments, includes cores 101A-B, where each core 101 may be configured to perform distinct graphical operations such as clipping, texturing, shading, rasterization, and/or the like. As an example, core 101A may perform vertex processing while core 101B may perform fragment processing. As such, different kicks included in a particular command buffer 125 may be executed at different ones of cores 101 or may also be executed on one of the cores.

In various embodiments, cores 101A-B are configured to perform context switching, where cores 101A-B complete the current task for a process (e.g., thread) and start tasks for a different process. As such, cores 101A-B may store the state of the current process to primary memory and retrieve a new or previous process from primary memory. As such, processing complex 100 may replace the data in L1 cache 105 and L2 cache 110 relating to a first process with data relating to a second process. Processing complex 100 may ensure that all in-flight tasks for a particular core 101 have completed before the particular core 101 switches to a different process. Furthermore, processing complex 100 may flush and invalidate portions of L1 cache 105 associated with the particular core 101 or the entire L1 cache 105. In various embodiments, processing complex 100 flushes the contents of L1 cache 105 prior to invaliding portions or all of L1 cache 105. In some embodiments, when flushing L1 cache 105, processing complex 100 writes the contents of L1 cache 105 to primary memory; in other embodiments, processing complex 100 writes the contents to L2 cache 110. Furthermore, cores 101A-B may receive a request to switch from a first thread to a second thread and, in response, replace data (cache lines) in L2 cache 110 relating to the first thread with data relating to the second thread.

In some embodiments, L1 cache 105 is configured to store blocks of data and tags in cache lines. In various embodiments, L1 cache 105 implements a set-associative caching scheme in which L1 cache 105 is configured to store a data block associated with a given address in one of multiple entries. When a request is received to store a data block at a particular address, a portion of the address (called an “index value”) may be used to select a particular set of entries (called a “line” or “way”) for storing the data block. The data block may then be stored in any cache line within the selected set. Furthermore, L1 cache 105 may tag the data with an identifier comprising a first portion that identifies a particular core 101 using (i.e. writing and reading) the stored data and a second portion specifying a virtual address associated with the stored data. As used herein, the phrase “tag portion” or “portion of a tag” refers to one or more bits of a tag that make up less than the entirety of the tag. In various embodiments, when a particular core 101 completes a kick, processing complex 100 flushes and invalidates the data associated with the particular core 101 that is stored by L1 cache 105. In some embodiments, L1 cache 105 receives requests from multiple cores 101 and stores the requests in a queue that it processes serially.

L2 cache 110, in some embodiments, is configured to store blocks of data in cache lines with a corresponding tag for each cache line. In various embodiments, L2 cache 110 implements a set-associative caching scheme similar to the caching scheme disclosed for L1 cache 105. As an example, L2 cache 110 may implement a 4-way set associative caching scheme in which L2 cache 110 may store a block of data in four possible entries (or cache lines) associated with a given address. L2 cache 110 or processing complex 100 may tag the blocks of data with an identifier comprising several portions for associating the data with cores, threads, command buffers, and/or addresses in memory. In various embodiments, flush controller 115 is configured to flush and invalidate portions or all of L2 cache 110. In some embodiments, flush controller 115 receives a request to flush and invalidate L2 cache 110 from processing complex 100. In some embodiments, processing complex 100 is configured to flush and invalidate portions or all of L2 cache 110 without the assistance of flush controller 115. Flush controller 115 may write data stored in L2 cache 110 to primary or secondary memory. In some embodiments, L2 cache 110 receives requests from multiple sources (e.g. cores 101) and stores the requests in a queue that it processes serially.

Command queue 120, in some embodiments, is configured to store command buffers 125 in a serial ordering. In the illustrated embodiment, command queue 120 is located within a portion of the GPU; in other embodiments, command queue 120 may be located outside the GPU. Command queue 120 may be configured with various numbers of entries in various embodiments. Command queue 120 may be implemented using dedicated storage elements or may be assigned a portion of a larger memory structure.

In various embodiments, CPU 140 is configured to generate a set of kicks, group them into a command buffer 125, and write the group as a command buffer into command queue 120. In order to maintain the serial ordering, command queue 120 may implement a first in, first out caching scheme. As an example, command queue 120 may receive command buffer 125A from CPU 140 and store it at the front of the queue. Thereafter, command queue 120 may receive command buffer 125B and store it directly behind command buffer 125A in the queue. In some embodiments, command queue 120 implements a different scheme that allows CPU 140 to write new command buffers 125 to positions in front of older command buffers 125 such that processing complex 100 retrieves newer command buffers 125 before earlier cached command buffers 125. Command queue 120, in various embodiments, is configured to receive a request from processing complex 100 for the command buffer 125 at the front of the queue and transmit the command buffer 125 to processing complex 100 via interconnect 122.

MMU 130, in some embodiments, is configured to translate virtual address 117 into a physical address for retrieving data from memory. In the illustrated embodiment, MMU 130 receives virtual address 117 and a context ID from L2 cache 110; in other embodiments, MMU 130 may receive virtual address 117 from other circuitry (e.g., processing complex 100). In some embodiments, MMU 130 includes a translation lookaside buffer (TLB) 135 that may improve virtual address translation speed. Furthermore, TLB 135 may store page tables that map virtual addresses 117 to physical addresses. In one embodiment, upon TLB 135 determining that the current page tables do not include the desired mapping, MMU 130 is configured to send a page table request to primary memory and receives, in response, a page table that includes the desired mapping. In various embodiments, upon translating virtual address 117, MMU 130 sends a request for data, which includes the physical address, to primary memory via fabric 150. When flush controller 115 receives a request to flush and invalidate L2 cache 110, MMU 130 may receive several requests, from flush controller 115, for translating virtual address 117 into a physical address to assist flush controller 115 in writing data to primary memory. In some embodiments, MMU 130 receives a virtual address 117 and data and writes the data to primary memory based on the physical address of virtual address 117.

Turning now to FIG. 2A, a timing diagram of the execution of command buffers 125 within the GPU is shown, according to some embodiments. In the illustrated embodiment, command streams 220A-C correspond to cores 101 that configured to receive one or more command buffers 125. In other embodiments, a single core may execute schedulers for different types of work. In the illustrated embodiment, there are three command streams namely a compute data master (CDM) that handles general computation operations, a vertex data master (VDM) that performs vertex processing, and a pixel data master (PDM) that performs fragment processing.

In the illustrated embodiment, command buffer 125 includes a set of kicks that span across multiple command streams 220. As such, command streams 220 may execute the different kicks included in the same particular command buffer 125. For example, in the illustrated embodiment and with respect to “cbuf 0,” kick “k1” and kick “k2” are executed on command stream 220A and command stream 220B respectfully, yet the two kicks are grouped in a single command buffer “cbuf0.” In the illustrated embodiment, multiple flush requests 230A-F are issued to flush and invalidate portions or all of L2 cache 110 in response to finishing execution of particular command buffers.

Kick 210, in the illustrated embodiments, is a grouping of rendering commands for rendering one or more objects to be displayed. As an example, kick 210 may include rendering commands for drawing an icon to a display screen. In some embodiments, processing complex 100 or CPU 140 programs kick 210 with a command buffer ID and/or a context ID, which the context ID associates kick 210 with a process and a memory context. In various embodiments, L2 cache 110 or processing complex 100 tags blocks of data stored by L2 cache 110 with the command buffer ID and the context ID of a corresponding kick. In some embodiments, a first kick that precedes a second kick of a different command buffer may write data to L2 cache 110 that is usable by the second kick. As such, L2 cache 110 may update the tag associated with the data so that the tag indicates the different command buffer and/or a different context. In some embodiments, after the completion of a kick, the data associated with the kick becomes available to other cores 101 and other command streams 220. For example, when VDM command stream 220B completes “cbuf 0, kick 0,” then the other command streams A and C may use the data manipulated by “kick 0.” In some embodiments, after the completion of a command buffer, the data associated with the command buffer becomes available to a CPU and/or other circuitry outside the GPU.

In some embodiments, a first command stream 220 operates concurrently with a second command stream 220. As such, the second command stream 220 may read data written by the first command stream 220. Furthermore, the first command stream 220 may write data into a first portion of a cache line and the second command stream 220 may write data into a second portion of the same cache line (i.e. command streams 220 may share cache lines). In some embodiments, upon writing data to a first portion of a cache line, command stream 220 may invalidate the non-dirty data of the other entries of the same cache line. As such, when performing a read operation, command stream 220 may determine the entries of the cache line that include non-dirty data and perform a partial fill of those entries with a fresh copy of data from memory. In various embodiments, in response to changing from a first command buffer to a second command buffer, command stream 220 determines the portions of data stored in cache lines relating to the first command buffer that include non-dirty data and invalidates those portions of the cache lines or the entirety of the cache lines.

In some embodiments, the second command stream 220 may halt execution of instructions to wait for a trigger event associated with the first command stream 220. In various embodiments, command streams 220 are configured to serially execute instructions included in a given command buffer. In response to starting execution of a second command buffer, the command streams 220 may update the tags relating to a first command buffer such that the tags indicate the second command buffer. For example, when ownership of particular cache lines changes from “cbuf0” to “cbuf2,” command stream 220 may send a request to L2 cache 110 to write data into a portion of the tags associated the particular cache lines, which the data indicates “cbuf2.” In some embodiments, upon switching from the first command buffer to the second command buffer, command stream 220 sets each multiple ID (discussed below with reference to FIG. 2B) associated with the particular cache lines to true.

Flush events 230, in some embodiments, are requests to flush and invalidate cache lines in L2 cache 110, upon completion of a corresponding command buffer. In the illustrated embodiment, each flush 230A-F occurs after the last kick of a given command buffer; however, flushes may occur at other periods during the execution of a command buffer in other embodiments. Flush events 230 may be requests from a program that includes the particular command buffer to be flushed. In some embodiments, a flush event causes flush controller 115 to write blocks of data from the cache lines to a primary memory before invaliding the cache lines; in other embodiments, a flush event causes flush controller 115 to invalidate the cache lines before writing the data to primary memory. Furthermore, a flush event may cause flush controller 115 to concurrently write the data to primary memory and invalidate the cache lines. In addition to targeting cache lines associated with a given command buffer that completed, a flush may further cause flush controller 115 to flush and invalidate other cache lines based on additional identifiers (e.g. multiple ID 290 disclosed in FIG. 2B and discussed below).

Turning now to FIG. 2B, an exemplary tag 250 is shown, according to some embodiments. In the illustrated embodiment, tag 250 includes command buffer ID 260, context ID 270, virtual address 280, and multiple ID 290. In some embodiments, tag 250 may include additional or less identifiers. Furthermore, each identifier or portion may make up a different size relative to the entirety of tag 250. For example, multiple ID 270 may be one bit while command buffer ID 260 may include multiple bits. In some embodiments, the portions or identifiers may be arranged in any order within tag 250. As an example, while multiple ID 270 appears on the far left of tag 250 in the illustrated embodiments, multiple ID 270 may appear on the far right of tag 250. In some embodiments, processing complex 100 and/or flush controller 115 (cache 110) are configured to parse tag 250 into smaller portions. Furthermore, processing complex 100 or cache 110 may generate tag 250 for tagging data stored in a cache line of L2 cache 110. In various embodiments, tag 250 may be implemented differently than shown; the illustrated implementation is included for purposes of discussion but is not intended to limit the scope of the present disclosure.

Command buffer ID 260, in one embodiment, is a portion of tag 250 that indicates a particular command buffer whose instructions have been executed by a core 101 to manipulate and/or store data in a cache line associated with tag 250. In various embodiments, a GPU or a CPU programs each kick 210 with a particular command buffer ID 260 prior to executing the kick 210. In some embodiments, the GPU or the CPU is configured to rotate through a set of command buffer IDs 260 where the set is based on the portion size of command buffer ID 260. As example, command buffer ID 260 may comprise four bits and, as such, the GPU may start at zero (i.e. a numerical value associated with a particular command buffer) and progress to fifteen (2⁴−1). Thereafter, the GPU may restart at zero and again progress to fifteen in a continuous cycle. In one embodiment, a small portion size for command buffer ID 260 may limit the number of command buffers that can be generated at a given time. On the other hand, a smaller ID field 260 may reduce power consumption in a content-addressable memory (CAM) used to check for matching tags. In some embodiments, in response to receiving a flush and invalidate request from processing complex 100, flush controller 115 is configured to use command buffer ID 260 to determine the cache lines storing data for the associated command buffer that need to be flushed and invalidated. Accordingly, flush controller 115 may flush the cache lines indicated by command buffer ID 160 and, afterwards, invalidate those cache lines.

Context ID 270, in some embodiments, is a portion of tag 250 that indicates a particular process or memory context using (e.g., writing and reading) data stored in a cache line associated with tag 250. In various embodiments, processing complex 100 programs each kick 210 with a particular context ID 270 prior to executing the kick 210. In various embodiments, processing complex 100 is configured to cycle through a set of context IDs 270 (similar to command buffer ID 260). When L2 cache 110 performs a hit check to determine whether requested data is stored in a cache line, L2 cache 110 may compare context ID 270 and virtual address 280 against the corresponding portions of tag 250 of a cache line that is associated with the requested data. In various embodiments, cache 110 receives a request from processing complex 100 to write data for a first process (i.e. save the current state) to primary memory. As such, cache 110 may use context ID 270 to determine the cache lines storing data for the process, request translations of virtual addresses 117 by MMU 130 into physical addresses, and write the data to primary memory at the physical addresses. Furthermore, cache 110 may retrieve data for a second process and store the data in the cache lines indicated by the first process. Accordingly, cache 110 may update the particular context IDs 270 associated with the first process to indicate the second process.

Virtual address 280, in some embodiments, is a portion of tag 250 that indicates an address in virtual memory, which enables a GPU to extend the amount of memory available to processes running on the GPU. In various embodiments, the GPU generates several page tables that include translations for mapping virtual addresses 280 to physical addresses in memory. In some embodiments, when L2 cache 110 performs a hit check to determine whether requested data is stored in a cache line, L2 cache 110 compares virtual address 280 and context ID 270 against the corresponding portions of tag 250 of the cache line that is associated with the requested data.

Multiple ID 290, in some embodiments, is a portion of tag 250 that indicates whether data tagged with tag 250 has been manipulated or operated on by instructions in multiple command buffers. In some embodiments, multiple ID 290 is a single bit that evaluates to true or false; in other embodiments, multiple ID 290 is a set of bits that indicates the number of command buffers 125 that have operated on the data. For example, if an instruction in command buffer 125A writes a block of data to a particular portion in a cache line and an instruction in command buffer 125B writes data to a different portion in the same cache line, then L2 cache 110 may set the multiple ID 290 for that cache line to true. When flush controller 115 receives a request to invalidate and flush portions of L2 cache 110, flush controller 115 may invalidate and flush any cache line whose multiple ID 290 has been set to true irrespective of the command buffer associated with the cache line. In some embodiments, after flushing and invaliding portions or all of L2 cache 110, flush controller 115 or L2 cache 110 resets the multiple ID 290 to its default state (i.e. false).

While the present disclosure discusses flushing lines of an L2 cache based on a command buffer ID, the disclosed method may be used to flush lines of a cache based on other identifiers. In other words, the command buffer ID is just one specific case of using the disclosed method. For example, in some embodiments, an L1 cache may be invalidated and flushed based on a kick ID or other appropriate identifier. Moreover, while the present disclosure discusses flushing in the context of a GPU, the disclosed method may be applied to any circuit (e.g., a CPU) that includes storage elements that are flushed and/or invalidated.

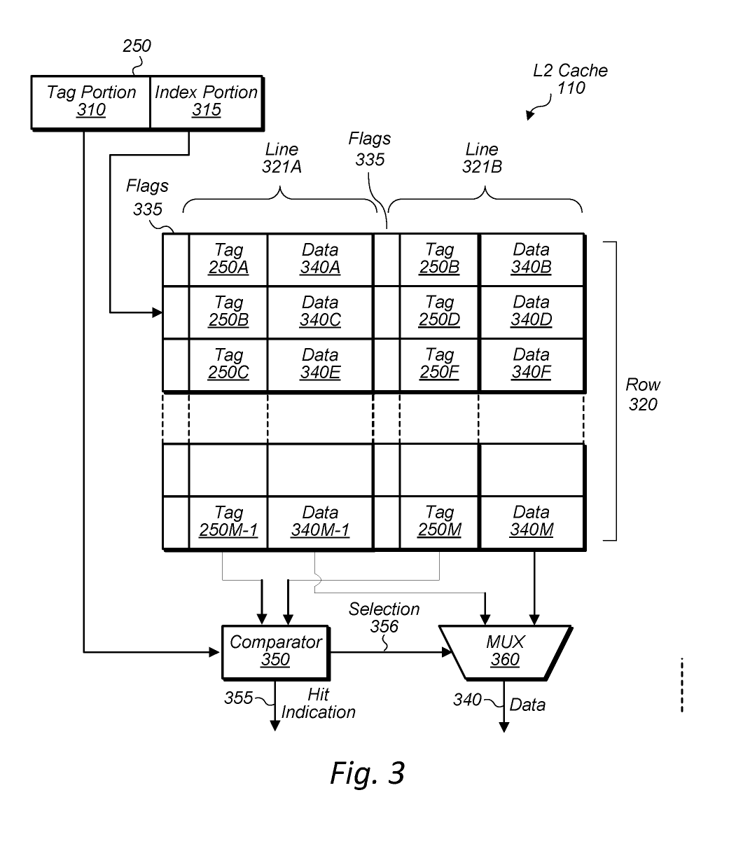

Turning now to FIG. 3, a block diagram of an exemplary L2 cache 110 is shown, according to some embodiments. In the illustrated embodiment, L2 cache 110 includes multiple cache rows 320 that each include lines 321A-B, which each line 321 includes tag 250, flags 335, and data 340. While L2 cache 110 is shown as a two-way set associative cache for simplicity, L2 cache 110 may be an N-way set-associative cache or a fully set-associative cache. In other embodiments, L2 cache 110 is not a set-associative cache. Furthermore, L2 cache 110 may include flush controller 115 (not explicitly shown). In some embodiments, L2 cache 110 is configured to receive index 315 and tag portion 310 from processing complex 100 or flush controller 115. L2 cache 110 may use index 315 to select a particular row 320 and send corresponding sections of lines 321A-B (e.g. tag 250, flags 335, and data 340) to comparator 350 and MUX 360. In the illustrated embodiment, comparator 350 sends hit indication 355 to processing complex 100 and selection 356 to MUX 360. Furthermore, MUX 360 may use selection 356 to select the particular data 340 between the two entries of data 340 to be sent to processing complex 100.

Tag portion 310, in some embodiments, is a portion of tag 250 that indicates whether requested data is stored in a particular line 321 of a row 320 identified by index portion 315. In the illustrated embodiment, tag portion 310 comprises a larger portion of tag 250 than index portion 315; however, in other embodiments, tag portion 310 comprises an equal or smaller portion of tag 250 than index portion 315. Furthermore, tag portion 310 may include several of the portions or identifiers of tag 250 discussed in FIG. 2B. As an example, for a hit request on L2 cache 110, tag portion 310 may include context ID 270 and virtual address 280.

Index portion 315, in some embodiments, is an identifier that indicates a particular row 320 where requested data may be stored. In the illustrated embodiment, index portion 315 comprises a smaller portion of tag 250 than tag portion 310; however, in other embodiments, index portion 315 comprises an equal or larger portion of tag 250 than tag portion 310. Index portion 315 may comprise a portion or all of virtual address 280. In some embodiments, L2 cache 110 uses index 315 to retrieve tags 250 and data 340 from lines 321A-B for a particular row 320 and transmit these values to comparator 350 and MUX 360 respectfully.

Rows 320, in some embodiments, are configured to store data 340 along with a corresponding tag 250 in lines 321. In the illustrated embodiment, lines 321 include flags 335, which include a valid bit that indicates whether a cache line 320 has been loaded with valid data 340. The valid bit may be used to invalidate cache lines 321 in conjunction with a flush operation. Furthermore, flags 335 may include a dirty bit that indicates whether data in a particular line 321 has been modified by processing complex 100 relative to data in memory. Lines 321, in some embodiments, are configured to transmit data 340 along with a portion or all of tag 250 (relating to the particular line 321 of a row 320 indicated by index portion 315) to comparator 350 and MUX 360 respectfully. Furthermore, cache 110 may receive multiple index portions 315 associated with multiple requests, and may maintain a queue of index portions 315 and tag portions 310.

Lines 321, in some embodiments, include one or more portions configured to store data. Consider, for example, an implementation in which a particular line 321 may have four portions in which each portion is capable of storing a byte of data. In some embodiments, each portion of a particular line 321 includes a set of flags (e.g. invalid bit, dirty bit, etc.) and, as such, each portion may be invalidated. In some embodiments, some tags apply to the entire cache line while other tags or masks indicate the state of individual portions. For example, a valid bit may apply to an entire cache line while a dirty bit is maintained for each portion of the cache line. In some embodiments, processing complex 100 or L2 cache 110 determines that a portion of a particular line 321 has been invalidated and, in response, retrieves a fresh copy of the data for that portion from memory and updates that portion with the fresh copy while preserving the data stored in other portions of the particular line 321. For example, a particular line 321 may include four portions A, B, C, and D and, in one embodiment, a command buffer causes data to be written to portions A and B. Furthermore, in some embodiments, processing complex 100 or L2 cache 110 sets the dirty bit to true for portions A and B and sets the valid bit to false for portions C and D. In other embodiments, processing complex 100 or L2 cache 110 sets the dirty bit to true for portions A and B, retrieves a fresh copy of data for portions C and D from memory, and updates portions C and D with the fresh copy. In some embodiments, a command buffer X causes data to be written to portions A and B and a command buffer Y writes data to portions C and D. Furthermore, in response to switching to a command buffer Z after the completion of command buffer X, processing complex 100 or L2 cache 110 may invalidate portions A and B while preserving portions C and D. In some embodiments, in response to switching to a second command buffer, processing complex 100 or L2 cache 110 is configured to invalidate the non-dirty data for cache lines associated with a first command buffer.

Comparator 350, in some embodiments, is configured to compare a tag portion 310 and tags 250 of lines 321A-B for a particular row 320 to determine a match. In the illustrated embodiment, comparator 350 generates hit indication 355 based on the comparison and provides selection 356 to MUX 360 for selecting an entry of the particular row 320. In one embodiment, comparator 350 sends hit indication 355 to flush controller 115 to assist flush controller 115 in flushing and invalidating cache lines. Comparator 350, in some embodiments, receives tag portion 310 from processing complex 100 via interconnect 122. In other embodiments, flush controller 115 provides tag portion 310 to comparator 350. Comparator 350 may extract the portions or identifiers discussed in FIG. 2B from tag portion 310 and compare them to the corresponding portions or identifiers of tags 250 retrieved from lines 321. Comparator 350 may set a valid bit (included in flags 335) of a cache line 321 to true or false to invalidate or validate (respectfully) the cache line 321. In some embodiments, comparator 350 may set a dirty bit to true or false to cause future hits to retrieve clean data 340 for a particular line 321. As an example, in one embodiment, comparator 350 invalidates a cache line 321 in response to matching command buffer ID 260 of tag portion 310 with command buffer ID 260 of tag 250 stored in the cache line 321.

MUX 360, in some embodiments, is configured to select data 340 based on a selection 356 and send the selected data 340 to processing complex 100. In some embodiments, MUX 360 sends the selected data 340 to MMU 130 and/or other circuitry implemented in L2 cache 110 for writing (i.e. flushing) the selected data 340 to primary memory. In the illustrated embodiment, MUX 360 receives selection 356 from comparator 350 in response to a comparison performed by comparator 350. In some embodiments, MUX 360 may select data for all lines 321 of a particular row 320 and transmit, in a serial manner, the data to processing complex 100 and/or flush controller 115.

Furthermore, in some embodiments, L2 cache 110 receives a request to invalidate lines 320 in the cache based on a command buffer ID. In some embodiments, L2 cache 110 invalidates lines 320 without being instructed by other circuitry. L2 cache 110 may invalidate lines 320 without flushing them to memory. For example, if a particular line 320 does not store dirty data as indicated by corresponding flags 335, then L2 cache 110 may invalidate the particular line 320 without flushing it. As such, the methods disclosed for flushing and/or invalidating lines in a cache may be used to only invalidate lines in a cache.

In various embodiments, the disclosed combination of hardware circuitry and software commands may allow software to efficiently flush data from a hardware cache based on command buffer ID 260, for example, while leaving data for other command buffers or contexts untouched. Further, the disclosed techniques may reduce time spend flushing, which may increase the amount of data that the cache 110 is able produce in a given time interval, relative to implementations that do not indicate command buffer in a cache tag, for example.

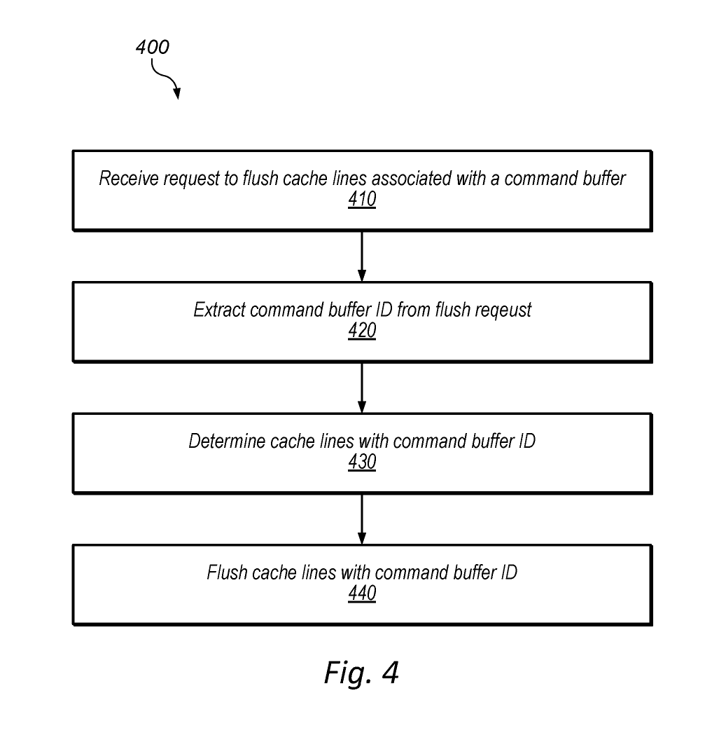

FIG. 4 is a flow diagram illustrating an exemplary method 400 for using cache tags that include a command buffer identifier, according to some embodiments. The method shown in FIG. 4 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

Method 400 may be performed by a cache such as cache 110. In some embodiments, method 400 may be performed by L2 cache 110, processing complex 100, or a combination thereof. In some embodiments, when processing complex 100 completes the last task for a particular command buffer, processing complex 100 sends a flush and invalidate request to cache 110.

At 410, in the illustrated embodiment, control circuitry (e.g., flush controller 115 of cache 110) receives a request to flush cache lines associated with a particular command buffer. In some embodiments, the request includes tag 250 comprising tag portion 310 and index portion 315. In some embodiments, tag portion 310 includes command buffer ID 260, context ID 270, virtual address 280, and multiple ID 290. In other embodiments, tag portion 310 may include one or more of the portions or identifiers discussed in FIG. 2B. Accordingly, in most embodiments, tag portion 310 includes command buffer ID 260 that identifies the cache lines to be flushed.

At 420, control circuitry retrieves tag portion 310 from the request and sends it to comparator 350, which extracts command buffer ID 260. In some embodiments, comparator 350 may extract one or more portions of tag portion 310. Furthermore, flush controller 115 may provide additional information indicating that the request is for a flush and invalidation of L2 cache 110. As such, comparator 350 may provide hit indication 355 to flush controller 115.

At 430, control circuitry retrieves index 315 from the request and sends it to rows 320, which provide the contents of the particular lines 321 whose address matches index 315 to comparator 350 and mux 360. In some embodiments, comparator 350 compares the extracted command buffer ID 260 and portions of tags 250 supplied by the particular lines 321 to determine lines 321 with tags 250 that include command buffer ID 260. Comparator 350 may compare other portions of tag portion 310 and portions of tags 250 supplied by the particular lines 321. Furthermore, comparator 350 may provide selection 356 to MUX 360 for selecting data 340

At 440, control circuitry (e.g., MUX 360) selects one or more of the data entries for the particular lines 321 (determined in step 430) and transmits the data 340 to flush controller 115. In some embodiments, flush controller 115 writes (i.e., flushes) the data 340 to a primary or secondary storage. In other embodiments, MUX 360 transmits the data 340 to processing complex 100, which writes the data 340 to memory. Furthermore, flush controller 115 may invalidate the particular lines 320 after writing their data to memory. In some embodiments, flush controller 115 invalidates the particular lines 320 without writing them to memory when the particular lines 320 are not dirty.

### Graphics Processing Overview

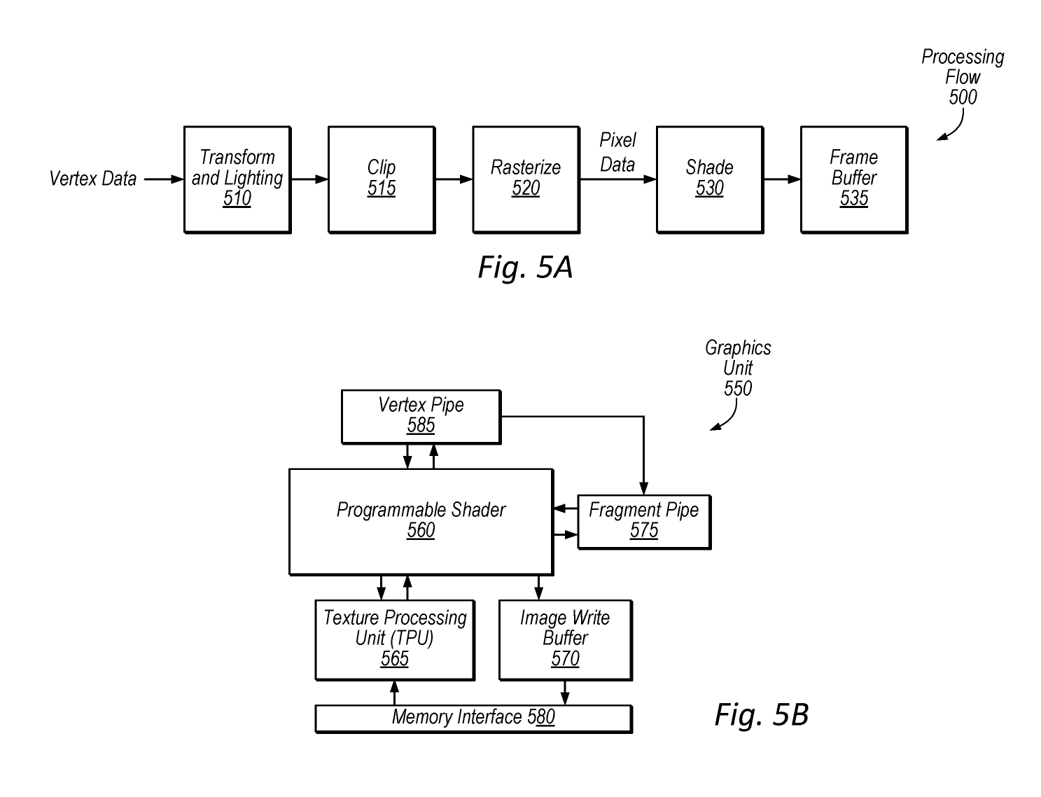

Referring to FIG. 5A, a flow diagram illustrating an exemplary processing flow 500 for processing graphics data is shown. In one embodiment, transform and lighting step 510 may involve processing lighting information for vertices received from an application based on defined light source locations, reflectance, etc., assembling the vertices into polygons (e.g., triangles), and/or transforming the polygons to the correct size and orientation based on position in a three-dimensional space. Clip step 515 may involve discarding polygons or vertices that fall outside of a viewable area. Rasterize step 520 may involve defining fragments or pixels within each polygon and assigning initial color values for each fragment, e.g., based on texture coordinates of the vertices of the polygon. Shade step 530 may involve altering pixel components based on lighting, shadows, bump mapping, translucency, etc. Shaded pixels may be assembled in a frame buffer 535. Modern GPUs typically include programmable shaders that allow customization of shading and other processing steps by application developers. Thus, in various embodiments, the exemplary steps of FIG. 5A may be performed in various orders, performed in parallel, or omitted. Additional processing steps may also be implemented.

Referring now to FIG. 5B, a simplified block diagram illustrating one embodiment of a graphics unit 550 is shown. In the illustrated embodiment, graphics unit 550 includes programmable shader 560, vertex pipe 585, fragment pipe 575, texture processing unit (TPU) 565, image write buffer 570, memory interface 580, and texture state cache 590. In some embodiments, graphics unit 550 is configured to process both vertex and fragment data using programmable shader 560, which may be configured to process graphics data in parallel using multiple execution pipelines or instances.

Vertex pipe 585, in the illustrated embodiment, may include various fixed-function hardware configured to process vertex data. Vertex pipe 585 may be configured to communicate with programmable shader 560 in order to coordinate vertex processing. In the illustrated embodiment, vertex pipe 585 is configured to send processed data to fragment pipe 575 and/or programmable shader 560 for further processing.

Fragment pipe 575, in the illustrated embodiment, may include various fixed-function hardware configured to process pixel data. Fragment pipe 575 may be configured to communicate with programmable shader 560 in order to coordinate fragment processing. Fragment pipe 575 may be configured to perform rasterization on polygons from vertex pipe 585 and/or programmable shader 560 to generate fragment data. Vertex pipe 585 and/or fragment pipe 575 may be coupled to memory interface 580 (coupling not shown) in order to access graphics data.

Programmable shader 560, in the illustrated embodiment, is configured to receive vertex data from vertex pipe 585 and fragment data from fragment pipe 575 and/or TPU 565. Programmable shader 560 may be configured to perform vertex processing tasks on vertex data which may include various transformations and/or adjustments of vertex data. Programmable shader 560, in the illustrated embodiment, is also configured to perform fragment processing tasks on pixel data such as texturing and shading, for example. Programmable shader 560 may include multiple execution instances for processing data in parallel.

TPU 565, in the illustrated embodiment, is configured to schedule fragment processing tasks from programmable shader 560. In some embodiments, TPU 565 is configured to pre-fetch texture data and assign initial colors to fragments for further processing by programmable shader 560 (e.g., via memory interface 580). TPU 565 may be configured to provide fragment components in normalized integer formats or floating-point formats, for example. In some embodiments, TPU 565 is configured to provide fragments in groups of four (a “fragment quad”) in a 2×2 format to be processed by a group of four execution pipelines in programmable shader 560.

Image write buffer 570, in the illustrated embodiment, is configured to store processed tiles of an image and may perform final operations to a rendered image before it is transferred to a frame buffer (e.g., in a system memory via memory interface 580). Memory interface 580 may facilitate communications with one or more of various memory hierarchies in various embodiments.

In various embodiments, a programmable shader such as programmable shader 560 may be coupled in any of various appropriate configurations to other programmable and/or fixed-function elements in a graphics unit. The exemplary embodiment of FIG. 5B shows one possible configuration of a graphics unit 550 for illustrative purposes.

### Exemplary Computer System

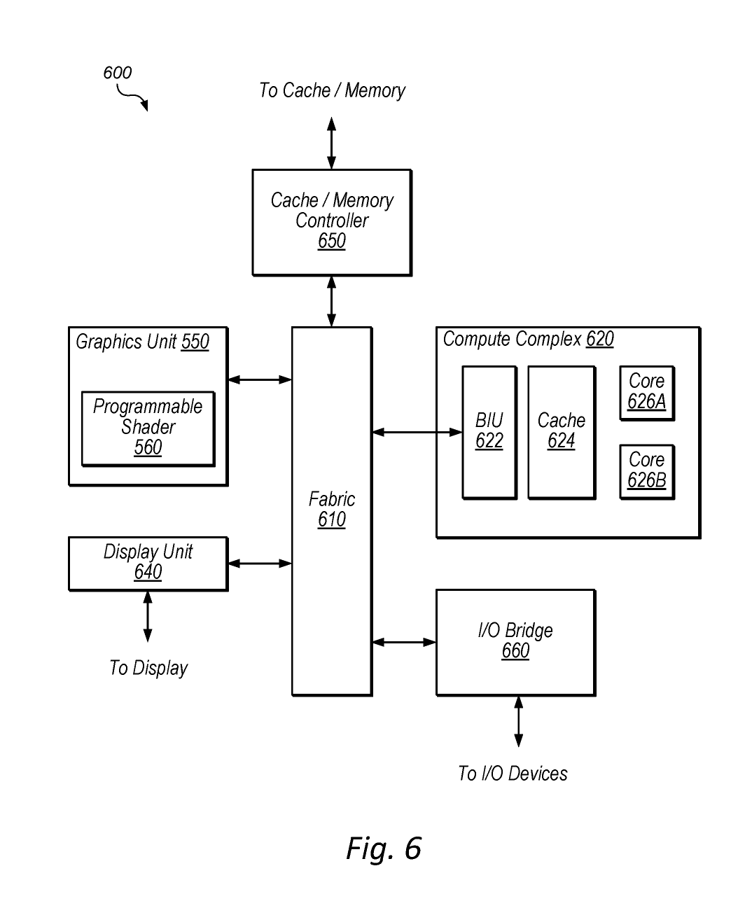

Turning now to FIG. 6, a block diagram illustrating an exemplary embodiment of a device 600 is shown. In some embodiments, elements of device 600 may be included within a system on a chip (SOC). In some embodiments, device 600 may be included in a mobile device, which may be battery-powered. Therefore, power consumption by device 600 may be an important design consideration. In the illustrated embodiment, device 600 includes fabric 610, processor complex 620, graphics unit 550, display unit 640, cache/memory controller 650, input/output (I/O) bridge 660.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally. As used herein, the term “coupled to” may indicate one or more connections between elements, and a coupling may include intervening elements. For example, in FIG. 6, graphics unit 550 may be described as “coupled to” a memory through fabric 610 and cache/memory controller 650. In contrast, in the illustrated embodiment of FIG. 6, graphics unit 550 is “directly coupled” to fabric 610 because there are no intervening elements.

In the illustrated embodiment, processor complex 620 includes bus interface unit (BIU) 622, cache 624, and cores 626A and 626B. In various embodiments, processor complex 620 may include various numbers of processors, processor cores and/or caches. For example, processor complex 620 may include 1, 2, or 4 processor cores, or any other suitable number. In one embodiment, cache 624 is a set associative L2 cache. In some embodiments, cores 626A and/or 626B may include internal instruction and/or data caches. In some embodiments, a coherency unit (not shown) in fabric 610, cache 624, or elsewhere in device 600 may be configured to maintain coherency between various caches of device 600. BIU 622 may be configured to manage communication between processor complex 620 and other elements of device 600. Processor cores such as cores 626 may be configured to execute instructions of a particular instruction set architecture (ISA), which may include operating system instructions and user application instructions. These instructions may be stored in computer readable medium such as a memory coupled to memory controller 650 discussed below.

Graphics unit 550 may include one or more processors and/or one or more graphics processing units (GPU's). Graphics unit 550 may receive graphics-oriented instructions, such as OPENGL®, Metal, or DIRECT3D® instructions, for example. Graphics unit 550 may execute specialized GPU instructions or perform other operations based on the received graphics-oriented instructions. Graphics unit 550 may generally be configured to process large blocks of data in parallel and may build images in a frame buffer for output to a display. Graphics unit 550 may include transform, lighting, triangle, and/or rendering engines in one or more graphics processing pipelines. Graphics unit 550 may output pixel information for display images. In the illustrated embodiment, graphics unit 550 includes programmable shader 560.

Display unit 640 may be configured to read data from a frame buffer and provide a stream of pixel values for display. Display unit 640 may be configured as a display pipeline in some embodiments. Additionally, display unit 640 may be configured to blend multiple frames to produce an output frame. Further, display unit 640 may include one or more interfaces (e.g., MIPI® or embedded display port (eDP)) for coupling to a user display (e.g., a touchscreen or an external display).

Cache/memory controller 650 may be configured to manage transfer of data between fabric 610 and one or more caches and/or memories. For example, cache/memory controller 650 may be coupled to an L3 cache, which may in turn be coupled to a system memory. In other embodiments, cache/memory controller 650 may be directly coupled to a memory. In some embodiments, cache/memory controller 650 may include one or more internal caches. Memory coupled to controller 650 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 650 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by processor complex 620 to cause device 600 to perform functionality described herein.

I/O bridge 660 may include various elements configured to implement universal serial bus (USB) communications, security, audio, and/or low-power always-on functionality, for example. I/O bridge 660 may also include interfaces such as pulse-width modulation (PWM), general-purpose input/output (GPIO), serial peripheral interface (SPI), and/or inter-integrated circuit (I2C), for example. Various types of peripherals and devices may be coupled to device 600 via I/O bridge 660. For example, these devices may include various types of wireless communication (e.g., wifi, Bluetooth, cellular, global positioning system, etc.), additional storage (e.g., RAM storage, solid state storage, or disk storage), user interface devices (e.g., keyboard, microphones, speakers, etc.), etc.

### Fabrication Overview

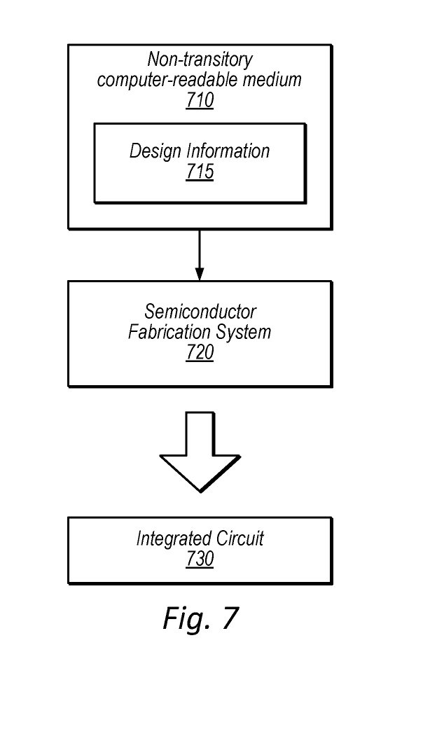

FIG. 7 is a block diagram illustrating a process of fabricating at least a portion of a processing circuit hardware resource allocation system. FIG. 7 includes a non-transitory computer-readable medium 710 and a semiconductor fabrication system 720. Non-transitory computer-readable medium 710 includes design information 715. FIG. 7 also illustrates a resulting fabricated integrated circuit 730. In the illustrated embodiment, semiconductor fabrication system 720 is configured to process design information 715 stored on non-transitory computer-readable medium 710 and fabricate integrated circuit 730.

Non-transitory computer-readable medium 710 may include any of various appropriate types of memory devices or storage devices. For example, non-transitory computer-readable medium 710 may include at least one of an installation medium (e.g., a CD-ROM, floppy disks, or tape device), a computer system memory or random access memory (e.g., DRAM, DDR RAM, SRAM, EDO RAM, Rambus RAM, etc.), a non-volatile memory such as a Flash, magnetic media (e.g., a hard drive, or optical storage), registers, or other types of non-transitory memory. Non-transitory computer-readable medium 710 may include two or more memory mediums, which may reside in different locations (e.g., in different computer systems that are connected over a network).

Design information 715 may be specified using any of various appropriate computer languages, including hardware description languages such as, without limitation: VHDL, Verilog, SystemC, SystemVerilog, RHDL, M, MyHDL, etc. Design information 715 may be usable by semiconductor fabrication system 720 to fabricate at least a portion of integrated circuit 730. The format of design information 715 may be recognized by at least one semiconductor fabrication system 720. In some embodiments, design information 715 may also include one or more cell libraries, which specify the synthesis and/or layout of integrated circuit 730. In some embodiments, the design information is specified in whole or in part in the form of a netlist that specifies cell library elements and their connectivity. Design information 715, taken alone, may or may not include sufficient information for fabrication of a corresponding integrated circuit (e.g., integrated circuit 730). For example, design information 715 may specify circuit elements to be fabricated but not their physical layout. In this case, design information 715 may be combined with layout information to fabricate the specified integrated circuit.

Semiconductor fabrication system 720 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 720 may also be configured to perform various testing of fabricated circuits for correct operation.

In various embodiments, integrated circuit 730 is configured to operate according to a circuit design specified by design information 715, which may include performing any of the functionality described herein. For example, integrated circuit 730 may include any of various elements described with reference to FIGS. 1-6. Further, integrated circuit 730 may be configured to perform various functions described herein in conjunction with other components. The functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

In some embodiments, a method of initiating fabrication of integrated circuit 730 is performed. Design information 715 may be generated using one or more computer systems and stored in non-transitory computer-readable medium 710. The method may conclude when design information 715 is sent to semiconductor fabrication system 720 or prior to design information 715 being sent to semiconductor fabrication system 720. Accordingly, in some embodiments, the method may not include actions performed by semiconductor fabrication system 720. Design information 715 may be sent to fabrication system 720 in a variety of ways. For example, design information 715 may be transmitted (e.g., via a transmission medium such as the Internet) from non-transitory computer-readable medium 710 to semiconductor fabrication system 720 (e.g., directly or indirectly). As another example, non-transitory computer-readable medium 710 may be sent to semiconductor fabrication system 720. In response to the method of initiating fabrication, semiconductor fabrication system 720 may fabricate integrated circuit 730 as discussed above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A graphics processing unit, comprising:
a cache that includes a plurality of cache lines; and
one or more storage elements configured to store a plurality of command buffers that include one or more instructions executable to manipulate data stored in the cache;
wherein ones of the cache lines in the cache are configured to store:
data to be operated on by instructions in one or more of the plurality of command buffers; and
a first tag portion that identifies a command buffer that has stored data in the cache line;
wherein the graphics processing unit is configured to:
receive a first request to flush cache lines that store data of a particular one of the plurality of command buffers; and
flush ones of the cache lines having first tag portions indicating the particular command buffer as having data stored in the cache lines and maintain data stored in other ones of the cache lines as valid.

2. The graphics processing unit of claim 1, wherein ones of the cache lines are configured to store:
a second tag portion that indicates whether instructions in multiple ones of the plurality of command buffers have been executed to manipulate data stored in the cache line; and
wherein the graphics processing unit is configured to:
flush, in response to the first request, ones of the cache lines having second tag portions that indicate manipulation of the data stored in the ones of the cache lines by the multiple ones of the plurality of command buffers.

3. The graphics processing unit of claim 2, wherein the graphics processing unit is configured to receive the first request from a program that includes the particular command buffer, wherein the first request includes an identifier of the particular command buffer.

4. The graphics processing unit of claim 1, wherein the graphics processing unit is configured to:
determine whether a portion of the data stored in ones of the cache lines includes non-dirty data of a first command buffer; and
invalidate the non-dirty data in response to changing the first tag portions from the first command buffer, indicated by the first tag portions, to a second command buffer.

5. The graphics processing unit of claim 1, wherein the graphics processing unit is further configured to:
receive a second request to replace the data stored in ones of the cache lines for a first memory context with data for a second memory context; and
replace the data stored in the one of the cache lines relating to the first memory context with the data for the second memory context.

6. The graphics processing unit of claim 1, further comprising:
a flush controller configured to receive the first request to flush the cache lines; and
a processor configured to execute a set of instructions to:
write information to the first tag portion, wherein the information indicates the particular command buffer; and
provide the first request to the flush controller.

7. The graphics processing unit of claim 1, wherein the instructions in the one or more of the plurality of command buffers include one or more rendering commands that specify a set of objects to be drawn to a display.

8. A non-transitory computer-readable medium having instructions stored thereon that are executable by a computing device to perform operations comprising:
generating a first identifier for a first command buffer that includes one or more instructions that are executable to manipulate data stored in a cache;
tagging one or more cache lines in the cache with the first identifier in response to execution of the one or more instructions in the first command buffer; and
sending a flush request to the cache, wherein the flush request indicates the first identifier, wherein the flush request causes ones of cache lines in the cache that are tagged with the first identifier to be flushed.

9. The computer-readable medium of claim 8, wherein the generating includes:
tagging the one or more cache lines with a value that indicates that a second command buffer has manipulated the data stored in the one or more cache lines associated with the first command buffer.

10. The computer readable medium of claim 9, wherein the operations further comprise:
receiving an indication that the second command buffer has manipulated data stored in a particular cache line associated with the first command buffer; and
writing information to a value of a tag relating to the particular cache line, wherein the information specifies a manipulation of the data stored in the particular cache line by the second command buffer.

11. The computer readable medium of claim 8, wherein the operations further comprise:
permitting a second command buffer to store information in the one or more cache lines associated with the first command buffer; and
in response to the permitting, invalidating non-dirty data stored in the one or more cache lines.

12. The computer readable medium of claim 8, wherein the generating includes:
tagging the one or more cache lines with a value that indicates a first thread relating to the first command buffer.

13. The computer readable medium of claim 12, wherein the operations further comprise:
determining whether to switch from the first thread to a second thread, and
in response to the determining, overwriting data stored in a particular cache line with new data relating to the second thread based on the value associated with the particular cache line indicating the first thread.

14. The computer readable medium of claim 13, wherein the overwriting includes:
writing the data stored in the one or more cache lines into a memory; and
receiving the new data from the memory.

15. A non-transitory computer readable storage medium having stored thereon design information that specifies a design of at least a portion of a hardware integrated circuit in a format recognized by a semiconductor fabrication system that is configured to use the design information to produce the circuit according to the design, including:
cache circuitry configured to:
store, in ones of a plurality of cache lines:
data to be operated on by a set of instructions in one or more command buffers; and
a first tag portion that identifies a first command buffer that has stored data in a particular cache line; and
perform a comparison of first tag portions of the plurality of cache lines and an identifier specifying the particular command buffer; and
execution circuitry configured to:
execute the set of instructions in the one or more command buffers to manipulate the data stored in the plurality of cache lines;
receive a request to flush ones of the plurality of cache lines that store data associated with a particular command buffer; and
wherein the circuit is configured, in response to the comparison, to flush ones of the plurality of cache lines having the first tag portions matching the identifier specifying the particular command buffer.

16. The computer readable medium of claim 15, wherein the design information specifies that the cache circuitry is further configured to store in the cache lines:
a second tag portion that identifies whether the execution circuitry has executed sets of instructions in two or more command buffers to manipulate the data stored in a cache line.

17. The computer readable medium of claim 16, wherein design information specifies that the execution circuitry is further configured to:
flush ones of the plurality of cache lines having second tag portions identifying a manipulation of the data stored in the ones of the plurality of cache lines by the two or more command buffers.

18. The computer readable medium of claim 15, wherein the design information specifies that the execution circuitry is further configured to:
execute instructions in a second command buffer to store information in particular cache lines associated with the first command buffer; and
in response to executing the instructions in the second command buffer, invalidate non-dirty data stored in the particular cache lines.

19. The computer readable medium of claim 15, wherein the design information specifies that the execution circuitry is further configured to:
perform a determination as to whether to switch from a first memory context to a second memory context; and
in response to the determination, replace the data stored in the cache lines relating to the first memory context with a set of data relating to the second memory context.

20. The computer readable medium of claim 19, wherein design information specifies that the cache circuitry is further configured to store, in the cache lines:
a third tag portion that identifies a particular memory context associated with the data stored in a cache line.
